(19) United States
(12) Patent Application Publication
(10) Pub. No.: US 2025/0356436 A1
(43) Pub. Date: Nov. 20, 2025

(54) SYSTEM AND METHOD FOR REAL-TIME IMPACT ASSESSMENT OF SOCIAL MEDIA POSTS WITH GENERATIVE ARTIFICIAL INTELIGENCE

(71) Applicant: NICE LTD., Ra'anana (IL)

(72) Inventors: Salil DHAWAN, Pune (IN); Nishu BANSAL, Pune (IN); Ashish KHATRI, Pune (IN)

(21) Appl. No.: 18/664,331

(22) Filed: May 15, 2024

(51) Int. Cl. G06Q 50/00

(52) U.S. Cl. CPC G06Q 50/01

(57) ABSTRACT

A computerized-method for dynamically prioritizing social-media interactions in real-time, based on social-media posts in feeds, in a contact-center. The computerized-method includes: (i) monitoring by processors the social-media posts in the feeds of one or more social-media platforms which are integrated to the contact center. The social-media posts have been published during a preconfigured period, for each social-media post of a customer in each feed in the feeds: a. calculating a quality-score by operating an Artificial intelligence (AI) driven Content Quality Analysis (ACQA) module; and b. calculating a social-impact score based on the calculated quality score and one or more parameters; (ii) automatically prioritizing the social-media posts based on the calculated social-impact score to yield a priorities queue of social-media interactions. Each social-media post represents a social-media interaction, and (iii) automatically routing social-media interactions by a routine-engine to an available agent based on the yielded priorities queue of social-media interactions.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of data analysis using Artificial intelligence (AI), and more specifically to real-time impact assessment of social media posts with Generative AI.

### BACKGROUND

In today's contact center landscape, the surge of interactions from social-media posts in feeds within social platforms presents a pressing challenge. Contact centers are inundated with many social-media interactions, ranging from inquiries and feedback to complaints and praises. Agents handle multiple social interactions in near real-time. However, existing approach to prioritizing these interactions is relying on static metrics, such as, likes, negative content or timestamps. This static prioritization fails to account for the varying impact of each interaction, leading to inefficiencies and missed opportunities for meaningful engagement. Moreover, the existing static prioritization system doesn't adapt to changing circumstances, leading to incorrect prioritization due to factors, such as social media engagement of likes or negative content.

This incorrect prioritization and lack of dynamic prioritization may result in critical issues. For example, in emergency services which are increasingly adopting social platforms for communication, there is a need for a technical solution to provide dynamic prioritization to ensure that interactions seeking immediate assistance within social post/feeds are handled with the highest priority, preventing potential life-threatening delays.

In another example, delayed responses and inadequate prioritization can lead to customer dissatisfaction and brand impact. In the realm of social post/feeds, dissatisfaction spreads rapidly, affecting a company's brand reputation and long-term prospects. Increased negative sentiment can have lasting consequences.

In yet another example, agents bear the consequences of inadequate prioritization or lack of dynamic prioritization, facing the challenge of managing a multitude of social post/feeds interactions which may affect agents morale and attrition. This can lead to low employee morale and increased attrition rates, which, in turn, impact the quality of customer service.

In yet another example, to ensure agents catering to multiple social post/feeds can consistently provide high-quality service, there is a growing need for a technical solution that will dynamically prioritize interactions within social platforms. Such technical solution would empower agents to address interactions with the utmost relevance and urgency at any given moment, ultimately maximizing the impact on customers which are using social post/feeds.

In yet another example, different customer interactions have varying levels of urgency and importance. There is a need for a technical solution to dynamically prioritize these interactions, such that contact centers can ensure that critical issues are addressed promptly, leading to enhanced customer satisfaction and loyalty.

In yet another example, contact centers often have limited resources, including agent bandwidth and time. There is a need for a technical solution that will dynamically prioritize interactions to allow these resources to be allocated more efficiently, ensuring that agents focus on handling high-priority interactions first, which can lead to improved productivity and operational efficiency.

In yet another example, certain interactions, such as those related to emergencies or customer complaints, carry higher risk if not addressed promptly. There is a need for a technical solution to dynamically prioritize interactions to mitigate these risks by ensuring that these critical interactions receive immediate attention, reducing the likelihood of negative outcomes, such as reputational damage or customer churn.

In yet another example, customer needs and market dynamics are constantly evolving. There is a need for a technical solution to dynamically prioritize interactions to enable contact centers to adapt to these changes in real-time, ensuring that they can effectively respond to emerging issues or trends as they arise.

In yet another example, timely and personalized responses to customer inquiries or issues contribute to a positive brand image. There is a need for a technical solution to dynamically prioritize interactions to allow contact centers to deliver a superior customer experience, reinforcing brand loyalty and advocacy.

In yet another example, many contact centers operate under strict Service Level Agreements (SLAs), which dictate response times and resolution targets. There is a need for a technical solution to dynamically prioritize interactions to help contact centers meet these SLAs by ensuring that high-priority interactions are addressed within the required timeframe.

Accordingly, in response to these challenges, there is a need for a technical solution that will leverage Generative AI to calculate a real-time impact score for social media posts and feeds and will offer a dynamic prioritization technical solution that is tailored to the unique demands of the contact center, specifically focusing on social post in feeds.

### SUMMARY

There is thus provided, in accordance with some embodiments of the present disclosure, a computerized-method for dynamically prioritizing social-media interactions in real-time, based on social-media posts in feeds, in a contact center.

Furthermore, in accordance with some embodiments of the present disclosure, the computerized-method may include: (i) monitoring by one or more processors the social-media posts in the feeds of one or more social-media platforms which are integrated to the contact center. The social-media posts have been published during a preconfigured period, for each social-media post of a customer in each feed in the feeds: a. calculating a quality-score by operating an Artificial intelligence (AI) driven Content Quality Analysis (ACQA) module; and calculating a social-impact score based on the calculated quality score and one or more parameters; (ii) automatically prioritizing the social-media posts based on the calculated social-impact score to yield a priorities queue of social-media interactions. Each social-media post represents a social-media interaction, and (iii) automatically routing social-media interactions by a routine-engine to an available agent based on the yielded priorities queue of social-media interactions.

Furthermore, in accordance with some embodiments of the present disclosure, the ACQA module may include: (i) preprocessing text and media elements in the social-media post; (ii) analyzing the preprocessed text and the preprocessed media elements to yield one or more factors of quality; (iii) constructing a prompt for Large Language Model (LLM). The prompt includes the text of the post and instructions to assess the one or more factors of quality; (iv) sending the constructed prompt to be executed via an Application Programming Interface (API) platform of the LLM and receiving a response; (v) parsing the response to extract one or more quality-scores. The response is a string of text that includes a quality-score for each quality factor in the one or more factors of quality; and (vi) calculating a total-content quality score, by summing the one or more quality-scores based on each quality-score preconfigured weight.

Furthermore, in accordance with some embodiments of the present disclosure, the one or more factors of quality may include at least one of: (i) relevance; (ii) accuracy; (iii) clarity; (iv) sentiment; and (v) total-quality.

Furthermore, in accordance with some embodiments of the present disclosure, the one or more parameters may include at least one of: (i) user reach; (ii) engagement metrics; (iii) social-media post relevance; (iv) social-media post accuracy; (v) social-media post clarity; (vi) response time sensitivity; (vii) customer emotion intensity; (viii) contextual keywords; (ix) customer sentiment; (x) customer loyalty; and (xi) customer feedback.

Furthermore, in accordance with some embodiments of the present disclosure, the customer loyalty parameter of the customer may be retrieved by the computerized-method further includes operating a social-media-feeds computation module.

Furthermore, in accordance with some embodiments of the present disclosure, the social-media-feeds computation module may include retrieving the customer loyalty parameter of the customer, from a customers-database. The computerized-method may further include: a. constructing a social-impact-prompt LLM, that includes the text of the post; and b. instructions to assess at least one parameter of: (i) user reach; (ii) engagement metrics; (iii) social-media post relevance; (iv) social-media post accuracy; (v) social-media post clarity; (vi) response time sensitivity; (vii) customer emotion intensity; (viii) contextual keywords; (ix) customer sentiment; and (x) customer feedback; and b. sending the constructed social-impact-prompt to be executed via an API platform of the LLM and receiving a response that includes a score for each parameter.

Furthermore, in accordance with some embodiments of the present disclosure, the processing of the text may include at least one of: (i) tokenizing; (ii) lowercasing; (iii) removing punctuation and stop-word; (iv) text-feature extraction. The text-feature extraction includes at least one of: (i) word frequency; (ii) Term Frequency-Inverse Document Frequency (TF-IDF); (iii) word embeddings; and (iv) contextual embeddings.

Furthermore, in accordance with some embodiments of the present disclosure, the processing media elements may include at least one of: (i) resizing; (ii) normalization; and (iii) visual-feature extraction. The visual-feature extraction may be operated by at least one of: (i) Convolutional Neural Networks (CNNs); and (ii) pretrained models.

Furthermore, in accordance with some embodiments of the present disclosure, the analyzing of the preprocessed text may be performed by applying at least one of: (i) Natural Language Processing (NLP); (ii) sentiment analysis; and (iii) readability analysis. The analyzing of the preprocessed media elements is operated by visual content analysis, said visual content analysis includes at least one technique of: (i) object detections; (ii) image classification; and (iii) content moderation.

Furthermore, in accordance with some embodiments of the present disclosure, the computerized-method may further include normalizing the calculated total-content quality score to a standardized scale.

Furthermore, in accordance with some embodiments of the present disclosure, the LLM may be continuously trained using labeled data updates to adapt to evolving content types and quality standards over time.

Furthermore, in accordance with some embodiments of the present disclosure, the computerized-method may further include forwarding the calculated social-impact score of each social-media post and the related social-media post to a recommendation engine. The recommendation engine may include sending the calculated social-impact score of each social-media post and the related social-media post to at least one of: (i) knowledgebase; (ii) agent-dashboard; (iii) reporting module; and (iv) supervisor dashboard.

Furthermore, in accordance with some embodiments of the present disclosure, the calculated social-impact score may be calculated according to formula I:

$$social - impact score = \sum ( user reach * W 1 ) + ( engagement metrics * W 2 ) + ( social - media interaction relevance * W 3 ) + ( social - media post accuracy * W 4 ) + ( social - media post clarity * W 5 ) + ( response time sensitivity * W 6 ) + ( customer emotion intensity * W 7 ) + ( contextual keywords * W 8 ) + ( customer sentiment * W 9 ) + ( customer loyalty * W 10 ) + ( customer feedback * W 11 ) , \qquad ( I )$$

whereby:
the user reach is a parameter that measures an influence of the customer,
the engagement metrics is a parameter that assesses level of engagement generated by the social-media post,
the social-media interaction relevance is a parameter that evaluates relevance of the social-media post to objectives of the contact center,
the social-media post accuracy is a parameter that refers to correctness of information presented in the social-media post,
the social-media post clarity is a parameter that assesses readability and comprehensibility of language used in the social-media post,
the response time sensitivity is a parameter that indicates urgency of the content of the social-media post,
the customer emotion intensity is a parameter that evaluates strength of emotions expressed in the social-media post,
the contextual keywords is a parameter that reflects an analysis of presence of keywords relevant to domain of the contact center,
the customer sentiment is a parameter that assesses overall sentiment of the social-media post,
the customer loyalty is a parameter that measures loyalty of the customer,
the customer feedback is a parameter that captures response of other customers to the social-media post, and
W1-W11 are preconfigured weights assigned to the parameters.

There is further provided, in accordance with some embodiments of the present disclosure, a computerized-system for dynamically prioritizing social-media interactions in real-time, based on social-media posts in feeds, in a contact center.

Furthermore, in accordance with some embodiments of the present disclosure, the computerized-system may include one or more processors. The one or more processors may be configured to: (i) monitor by one or more processors the social-media posts in the feeds of one or more social-media platforms which are integrated to the contact center. The social-media posts have been published during a preconfigured period; (ii) for each social-media post of a customer in each feed in the feeds: a. calculate a quality-score by operating an Artificial intelligence (AI) driven Content Quality Analysis (ACQA) module; and b. calculate a social-impact score based on the calculated quality score and one or more parameters; (iii) automatically prioritize the social-media posts based on the calculated social-impact score to yield a priorities queue of social-media interactions. Each social-media post represents a social-media interaction, and (iv) automatically route social-media interactions by a routine-engine to an available agent based on the yielded priorities queue of social-media interactions.

### BRIEF DESCRIPTION OF THE DRAWINGS

FIG. 1A schematically illustrates a high-level diagram of a contact center handling social-media interactions;

FIGS. 1B-1C schematically illustrate a high-level diagram of a system for dynamically prioritizing social-media interactions in real-time, based on social-media posts in feeds, in a contact center, in accordance with some embodiments of the present disclosure;

FIG. 2 is a high-level workflow of a computerized-method for dynamically prioritizing social-media interactions in real-time, based on social-media posts in feeds, in a contact center, in accordance with some embodiments of the present disclosure;

FIG. 3 is a diagram showing Artificial intelligence (AI) driven Content Quality Analysis (ACQA) module and parameters for calculating a social-impact score based on the calculated quality score and the parameters, in accordance with some embodiments of the present disclosure;

FIG. 4 is a diagram showing content quality score and customer loyalty score for calculating social-impact score, in accordance with some embodiments of the present disclosure;

FIG. 5 is a diagram showing interaction management factors, in accordance with some embodiments of the present disclosure;

FIG. 6 is a high-level workflow of a recommendation engine, in accordance with some embodiments of the present disclosure;

FIG. 7 is a diagram showing routing interactions using the social-impact score, in accordance with some embodiments of the present disclosure;

FIG. 8 is a high-level workflow for dynamically prioritizing social-media interactions in real-time, based on social-media posts in feeds, in accordance with some embodiments of the present disclosure;

FIG. 9 is a diagram for a system for dynamically prioritizing social-media interactions in real-time, based on social-media posts in feeds, in accordance with some embodiments of the present disclosure;

FIG. 10 is a high-level workflow for selecting a suitable agent to response to a social-media post, in accordance with some embodiments of the present disclosure;

FIG. 11 is a high-level workflow for selecting an agent having highest social-impact score to response to a social-media post, in accordance with some embodiments of the present disclosure; and

FIG. 12 is a screenshot of a UI for dynamically prioritizing social-media interactions in real-time, based on social-media posts in feeds, in a contact center, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

Current contact centers use multiple digital channels, however, there is a lack of dynamic prioritization of social-media interactions which are published via the social-media platforms as a social-media post.

The lack of dynamic prioritization may result in critical issues. For example, emergency services which are using social-media platforms for communication may need to ensure that interactions seeking immediate assistance within social-media post in feeds are handled with the highest priority, preventing potential life-threatening delays.

In another example, customer dissatisfaction and brand impact may be influenced by delayed responses and inadequate prioritization which can lead to customer dissatisfaction. Dissatisfaction spreads rapidly, via social-media platforms which immediately affecting a company's brand reputation and long-term prospects. Increased negative sentiment can have lasting consequences.

In yet another example, agent morale and attrition may be also influenced because agents bear the consequences of inadequate prioritization, facing the challenge of managing a multitude of social-media posts in the feeds, i.e., interactions. This can lead to low employee morale and increased attrition rates, which, in turn, impact the quality of customer service.

In yet another example, to minimize the impact of high-volume interactions on customers and to ensure agents catering to multiple social-media posts in the feeds and can consistently provide high-quality service, there is a need for a solution that will dynamically prioritize interactions within social-media platforms. Such a technical solution would empower agents to address interactions with the utmost relevance and urgency at any given moment.

In yet another example, to optimize customer experience, different customer interactions have varying levels of urgency and importance. By dynamically prioritizing these interactions, contact centers can ensure that critical issues are addressed promptly, leading to enhanced customer satisfaction and loyalty.

In yet another example, contact centers often have limited resources, including agent bandwidth and time. There is a need for a technical solution that will implement a dynamic prioritization that will allow these resources to be allocated more efficiently, ensuring that agents focus on handling high-priority interactions first, which can lead to improved productivity and operational efficiency.

In yet another example, certain interactions, such as those related to emergencies or customer complaints, carry higher risk if not addressed promptly. Therefore, there is a need for a technical solution that may implement dynamic prioritization to mitigate these risks by ensuring that these critical interactions receive immediate attention and reducing the likelihood of negative outcomes such as reputational damage or customer chum.

In yet another example, customer needs and market dynamics are constantly evolving. Therefore, there is a need for a technical solution that will implement dynamic prioritization to enable contact centers to adapt to these changes in real-time, thus ensuring that they can effectively respond to emerging issues or trends as they arise.

In yet another example, timely and personalized responses to customer inquiries or issues contribute to a positive brand image. Therefore, there is a need for a technical solution that will implement dynamic prioritization to allow contact centers to deliver a superior customer experience, reinforcing brand loyalty and advocacy.

In yet another example, many contact centers operate under strict Service Level Agreements (SLA)s, which dictate response times and resolution targets. Therefore, there is a need for a technical solution that may implement dynamic prioritization to meet these SLAs by ensuring that high-priority interactions are addressed within the required timeframe.

Accordingly, there is a need for a technical solution for leveraging Generative AI to calculate a real-time impact score for social-media posts in feeds, offering a dynamic prioritization solution tailored to the unique demands of the contact center.

There is a need for system and method dynamically prioritizing social-media interactions in real-time, based on social-media posts in feeds, of one or more social-media platforms which are integrated to the contact center.

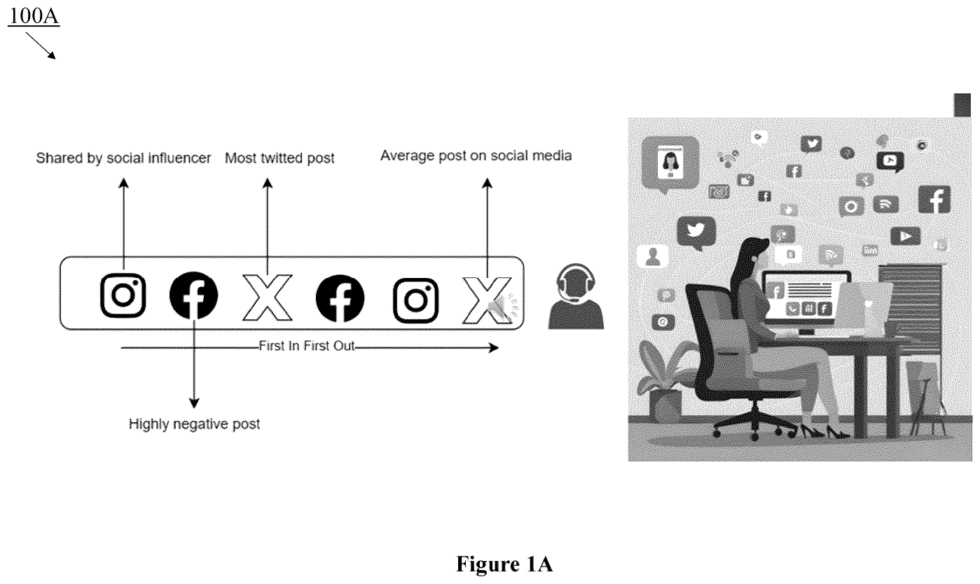

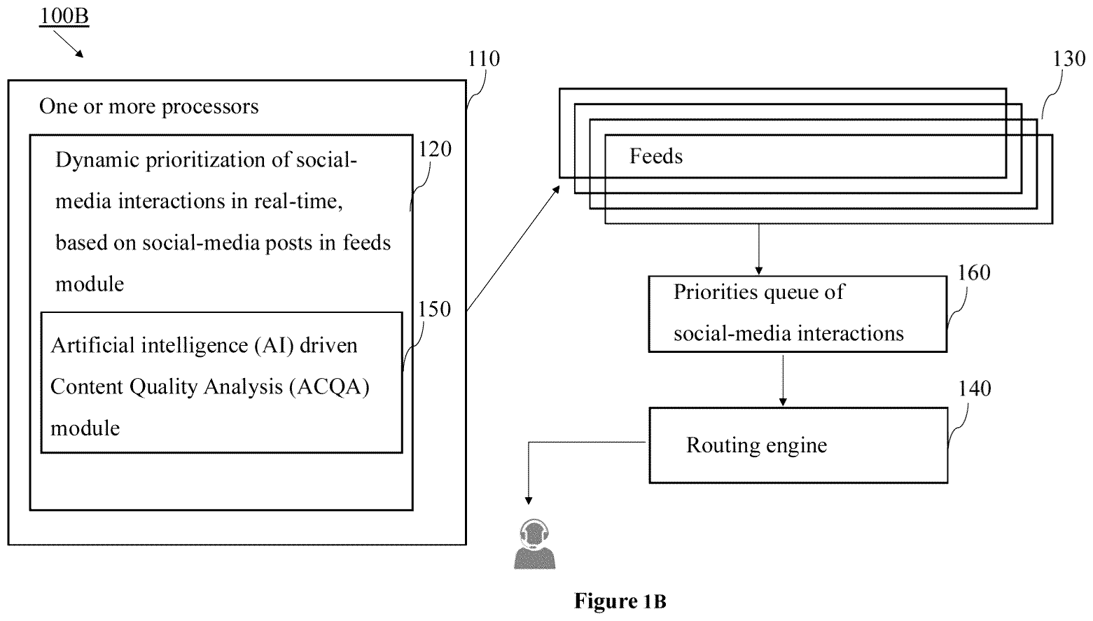

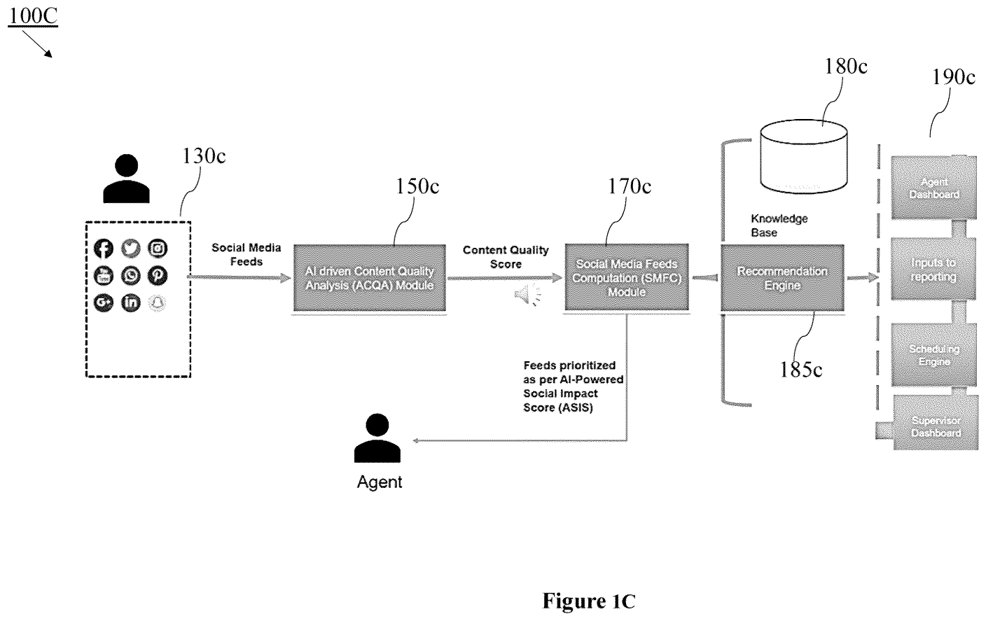

FIG. 1A schematically illustrates a high-level diagram of a contact center handling social-media interactions.

In current contact centers digital-media feeds are distributed to agents on first in, first out basis which may pose a challenge. Agents grapple with managing numerous real-time interactions originating from social-media posts and feeds on various platforms. The existing static prioritization system, rely on static roles and predefined rules, falls short in adapting to dynamic circumstances. The lack of prioritization for interactions presents a significant challenge, especially in managing high volumes of digital queries and demanding a robust and effective technical solution.

Currently there are no existing technical solutions for the problem that leverages AI-Powered Social Impact Score to enable precise and real-time prioritization of interactions, thereby addressing the challenge of managing a high volume of social media interactions in contact centers, ultimately enhancing customer satisfaction and operational efficiency. The existing static prioritization system doesn't adapt to changing circumstances, leading to incorrect prioritization due to factors such as number of likes or negative content.

Today's customers expect to connect with an agent for query resolution in every possible way. Having customer service as seamless as possible and with a quick turnaround-time through digital channels ensures high customer satisfaction.

Customer satisfaction is a measurement that determines how well a company's products or services meet customer expectations. It's one of the most important indicators of purchase intentions and customer loyalty. There is a need for a technical solution to address customer queries effectively and to provide a better customer experience and increasing conversions.

FIG. 1B schematically illustrates a high-level diagram of a system 100B for dynamically prioritizing social-media interactions in real-time, based on social-media posts in feeds, in a contact center, in accordance with some embodiments of the present disclosure.

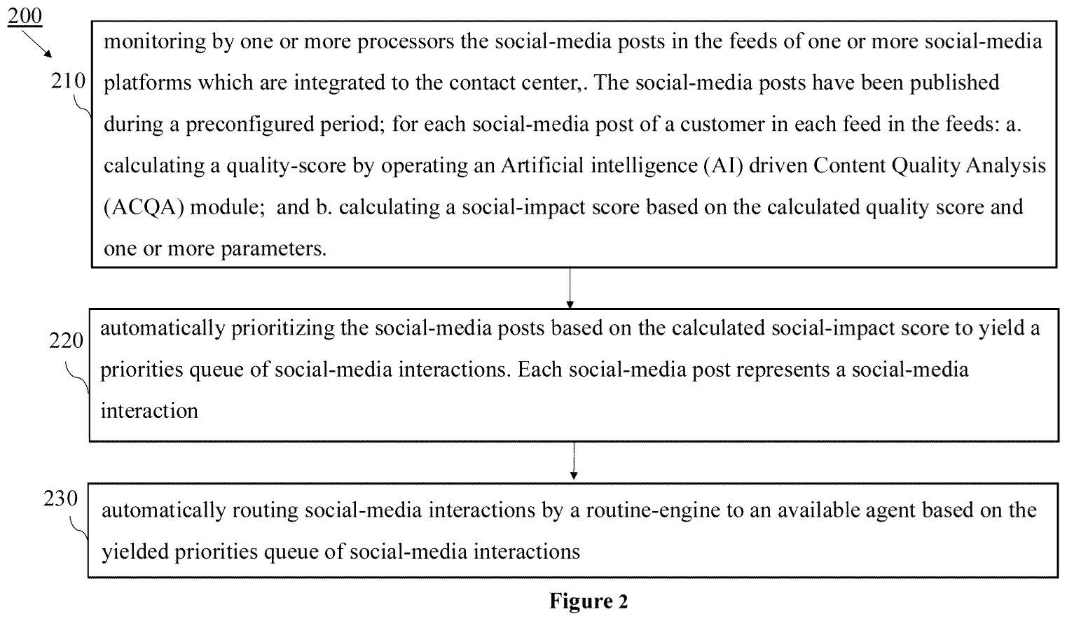

According to some embodiments of the present disclosure, a computerized system, such as system 100B for dynamically prioritize social-media interactions in real-time, based on social-media posts in feeds, in a contact center may implement a computerized-method, such as computerized-method 200 in FIG. 2 for dynamically prioritizing social-media interactions in real-time, based on social-media posts in feeds, in a contact center.

According to some embodiments of the present disclosure, system 100B may eliminate the need of creation of static roles for managing high quantum of digital queries and leverage the AI driven Content Quality Analysis (ACQA) module 150 to enable precise and real-time prioritization of interactions, thereby addressing the challenge of managing a high volume of social-media interactions, e.g., posts in feeds 130, in contact centers.

According to some embodiments of the present disclosure, for example, system 100B may identify emergency requests, dissatisfied customers, highly influential customers, by calculating a social-impact score which may impact the routing engine performance of interactions, e.g., social-media posts in the feeds 130 of the social media-platforms.

According to some embodiments of the present disclosure, one or more processors 110 may operate the dynamic prioritization of social-media interactions in real-time, based on social-media posts in feeds module 120 which may utilize Artificial intelligence (AI) driven Content Quality Analysis (ACQA) module 150 for real-time prioritization of interactions, by calculating a quality-score. A social-impact score may be calculated based on the calculated quality-score and one or more parameters. Then, the social-media posts in the feeds 130 of social media platforms which are integrated to the contact center may be automatically prioritized, based on the calculated social-impact score.

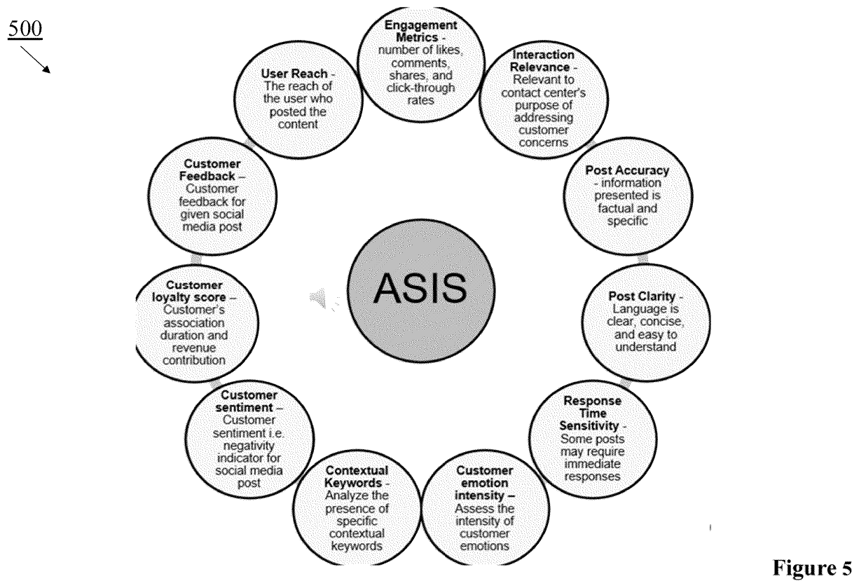

According to some embodiments of the present disclosure, the one or more parameters may be one of: (i) user reach; (ii) engagement metrics; (iii) social-media post relevance; (iv) social-media post accuracy; (v) social-media post clarity; (vi) response time sensitivity; (vii) customer emotion intensity; (viii) contextual keywords; (ix) customer sentiment; (x) customer loyalty; and (xi) customer feedback. For example, as shown in FIG. 5.

According to some embodiments of the present disclosure, the customer loyalty parameter may be retrieved by operating a social-media-feeds computation module (not shown). The social-media-feeds computation module may include retrieving the customer loyalty parameter of the customer, from a customers-database (not shown).

According to some embodiments of the present disclosure, a social-impact-prompt LLM may be constructed and may include the text of the social-media post and instructions to assess at least one parameter of: (i) user reach; (ii) engagement metrics; (iii) social-media post relevance; (iv) social-media post accuracy; (v) social-media post clarity; (vi) response time sensitivity; (vii) customer emotion intensity; (viii) contextual keywords; (ix) customer sentiment; and (x) customer feedback. The constructed social-impact-prompt may be sent to be executed via an API platform of the LLM and a response that includes a score for each parameter may be received.

According to some embodiments of the present disclosure, the LLM may be continuously trained using labeled data updates to adapt to evolving content types and quality standards over time. The LLM may be implemented by Generative Pretrained Transformer (GPT) models. For example, GPT models developed by OpenAI®, which may generate coherent and contextually relevant text based on a given prompt.

According to some embodiments of the present disclosure, the social-impact score may be calculated according to formula I:

social-impact score=Σ(user reach*W1)+(engagement metrics*W2)+(social media interaction relevance*W3)+(social media post accuracy*W4)+(social media post clarity*W5)+(response time sensitivity*W6)+(customer emotion intensity*W7)+(contextual keywords*W8)+(customer sentiment*W9)+(customer loyalty*W10)+(customer feedback*W11), (I)
whereby:
the user reach is a parameter that measures an influence of the customer,
the engagement metrics is a parameter that assesses level of engagement generated by the social-media post,
the social-media post relevance is a parameter that evaluates relevance of the social-media post to objectives of the contact center,
the social-media post accuracy is a parameter that refers to correctness of information presented in the social-media post,
the social-media post clarity is a parameter that assesses readability and comprehensibility of language used in the social-media post,
the time sensitivity is a parameter that indicates urgency of the content of the social-media post,
the customer emotion intensity is a parameter that evaluates strength of emotions expressed in the social-media post,
the contextual keywords is a parameter that reflects an analysis of presence of keywords relevant to domain of the contact center,
the customer sentiment is a parameter that assesses overall sentiment of the social-media post,
the customer loyalty is a parameter that measures loyalty of the customer,
the customer feedback is a parameter that captures response of other customers to the social-media post, and
W1-W11 are preconfigured weights assigned to the parameters.

The sum of W1-W11 is 100%.

According to some embodiments of the present disclosure, a priorities queue of social-media interactions 160 may be yielded where each social-media post represents a social-media interaction. A routine-engine, such as routine engine 140 may automatically route social-media interactions to an available agent based on the yielded priorities queue of social-media interactions 160.

According to some embodiments of the present disclosure, the dynamic prioritization of social-media interactions in real-time, based on social-media posts in feeds module 120 may leverage Machine Learning (ML) algorithms, natural language processing techniques and real-time analytics to dynamically assess the impact of each social-media interaction, allowing contact center agents to prioritize responses based on the urgency and significance of the query, e.g., social-media interaction. Thus, ensuring that high-priority interactions receive prompt attention while low-priority ones are appropriately managed.

According to some embodiments of the present disclosure, system 100B may identify and prioritize emergency requests, dissatisfied customers, and highly influential public figures in real-time, by proactively addressing critical issues, i.e., routing of high social-impact score interaction, and amplifying positive interactions. Thus, system 100B may not only enhance customer satisfaction but may also safeguard brand reputation and improve overall customer experience.

According to some embodiments of the present disclosure, system 100B may further empower contact center agents with real-time analytics and predictive capabilities, thus enables organizations to anticipate customer needs, personalize interactions, and drive meaningful engagement. The dynamic prioritization of social-media interactions in real-time, based on social-media posts in feeds module 120 may evaluate the qualitative aspects of each interaction, by considering factors such as sentiment, relevance, and user influence, for example, as shown in FIG. 5.

According to some embodiments of the present disclosure, system 100B may provide real-time assessment by the continuous analysis of incoming social-media posts in the feeds 130 of the social-medial platforms which are integrated to the contact center and may ensure that contact center agents have access to the most up-to-date information, thus allowing them to prioritize their responses effectively and adapt to changing circumstances in real-time.

According to some embodiments of the present disclosure, a module, such as the dynamic prioritization of social-media interactions in real-time, based on social-media posts in feeds module 120 may be seamlessly integrated into existing contact center infrastructure, minimizing disruption, and maximizing the value of current investments. For example, it may be incorporated into an existing Customer Relationship Management (CRM) system and workflow processes, thus enhancing the capabilities of contact center agents without requiring significant changes to their existing workflows.

According to some embodiments of the present disclosure, for each social-media post of a customer in each feed in the feeds 130, the ACQA module 150 may preprocess text and media elements in the social-media post.

According to some embodiments of the present disclosure, the processing of the text in the social-media post may include at least one of: (i) tokenizing; (ii) lowercasing; (iii) removing punctuation and stop-word; (iv) text-feature extraction. The text-feature extraction may include at least one of: (i) word frequency; (ii) Term Frequency-Inverse Document Frequency (TF-IDF); (iii) word embeddings; and (iv) contextual embeddings.

According to some embodiments of the present disclosure, the processing of media elements in the social-media post may include at least one of: (i) resizing; (ii) normalization; and (iii) visual-feature extraction. The visual-feature extraction may be operated by at least one of: (i) Convolutional Neural Networks (CNNs); and (ii) pretrained models.

According to some embodiments of the present disclosure, the ACQA module 150 may analyze the preprocessed text and the preprocessed media elements to yield factors of quality and then construct a prompt for a Large Language Model (LLM). The prompt may include the text of the post and instructions to assess the factors of quality.

According to some embodiments of the present disclosure, the analyzing of the preprocessed text may be performed by applying at least one of: (i) Natural Language Processing (NLP); (ii) sentiment analysis; and (iii) readability analysis. The analyzing of the preprocessed media elements may be operated by visual content analysis. The visual content analysis may include at least one technique of: (i) object detections; (ii) image classification; and (iii) content moderation.

According to some embodiments of the present disclosure, the ACQA module 150 may send the constructed prompt to be executed via an Application Programming Interface (API) platform of the LLM and may receive a response. The response may be a string of text that includes a quality-score for each quality factor in the factors of quality and may be parsed to extract quality-scores.

According to some embodiments of the present disclosure, the ACQA module 150 may further calculate a total-content quality score, by summing the quality-scores based on each quality-score preconfigured weight.

According to some embodiments of the present disclosure, the factors of quality may include at least one of: (i) relevance; (ii) accuracy; (iii) clarity; (iv) sentiment; and (v) total-quality.

According to some embodiments of the present disclosure, the calculated total-content quality score to a standardized scale may be normalized to a standard scale.

According to some embodiments of the present disclosure, the calculated social-impact score may be presented to the available agent and thus inform the agent of the priority of the interaction, e.g., social-media post, that is assigned.

FIG. 1C schematically illustrates a high-level diagram of a system 100C for dynamically prioritizing social-media interactions in real-time, based on social-media posts in feeds, in a contact center, in accordance with some embodiments of the present disclosure.

According to some embodiments of the present disclosure, system 100C may include similar components as in system 100B in FIG. 1B.

According to some embodiments of the present disclosure, system 100C may monitor social-media posts in the feeds 130c, such as feeds 130 in FIG. 1B of one or more social-media platforms, which are integrated to the contact center. The social-media posts have been published during a preconfigured period.

According to some embodiments of the present disclosure, for each social-media post of a customer in each feed in the feeds 130c, a quality-score may be calculated by operating an Artificial intelligence (AI) driven Content Quality Analysis (ACQA) module 150c, such as ACQA module 150 in FIG. 1B.

According to some embodiments of the present disclosure, a module, such as Social Media Feeds Computation (SMFC) module 170c may calculate a social-impact score based on the calculated quality score and one or more parameters. The parameters may be for example, as shown in FIG. 5.

According to some embodiments of the present disclosure, the calculated social-impact score of each social-media post and the related social-media post may be forwarded to a recommendation engine 185c.

According to some embodiments of the present disclosure, the recommendation engine may send the calculated social-impact score of each social-media post and the related social-media post to other components 190c, such as, knowledgebase, agent-dashboard, reporting module, and supervisor dashboard.

According to some embodiments of the present disclosure, the calculated social-impact score may be a metric that evaluates the significance and effectiveness of social media interactions within the context of contact centers.

According to some embodiments of the present disclosure, the calculated social-impact score may provide a comprehensive assessment by considering various dimensions of social media interactions, ranging from user engagement metrics to the sentiment of customer feedback. It considers factors such as user reach, engagement metrics, relevance to the contact center's objectives, post accuracy, clarity, response time sensitivity, customer emotion intensity, contextual keywords, customer sentiment, loyalty, and feedback. For example, as shown in FIG. 5.

According to some embodiments of the present disclosure, each aspect, e.g., factor that is contributing to the calculated social-impact score calculation may be assigned a weight, reflecting its relative importance in determining the overall impact of a social media post. These weights may be calibrated to ensure that critical factors are given appropriate emphasis in the scoring process.

According to some embodiments of the present disclosure, the ACQA 150c may enable real-time assessment of social media interactions, allowing contact centers to prioritize and respond to posts promptly based on their perceived impact. This dynamic evaluation ensures that urgent or high-impact posts receive timely attention, thereby enhancing customer satisfaction and brand reputation.

According to some embodiments of the present disclosure, the ACQA 150c may be tailored to suit the specific requirements and objectives of each contact center. Organizations have the flexibility to adjust parameters and weights based on their unique priorities, industry dynamics, and customer preferences.

According to some embodiments of the present disclosure, the ACQA 150c may be seamlessly integrated with existing contact center systems and workflows, augmenting their capabilities with advanced analytics and decision-making tools. This integration empowers agents and supervisors to make informed decisions about resource allocation, response prioritization, and engagement strategies.

According to some embodiments of the present disclosure, the ACQA 150c may facilitate continuous improvement and refinement of social media engagement strategies by providing actionable insights into the effectiveness of different interaction types, content themes, and communication channels. Contact centers can leverage these insights to optimize their social-media presence, drive meaningful customer interactions, and achieve business objectives.

According to some embodiments of the present disclosure, the social-media platforms, and the related feeds 130c may be platforms where users share content. For example, Facebook®, Twitter®, Instagram®, and the like.

According to some embodiments of the present disclosure, the content quality score, that may be generated by the ACQA module 150c may reflect the quality of the content based on various parameters such as accuracy, relevance, and clarity, as shown for example, in FIG. 5.

According to some embodiments of the present disclosure, the SMFC module 170c may compute and process social media feeds, integrating various scores and factors to prioritize interactions effectively.

According to some embodiments of the present disclosure, a knowledge base, such as knowledge database 180c may be a repository of information and resources accessible to agents, containing valuable insights, Frequently Asked Questions (FAQs), and best practices to assist in addressing customer inquiries effectively.

According to some embodiments of the present disclosure, the calculated social-impact score of each social-media post and the related social-media post may be added to a queue. The recommendation engine 185c may send the calculated social-impact score of each social-media post and the related social-media post to one or more components 190c, such as knowledgebase, agent-dashboard, reporting module, and supervisor dashboard.

According to some embodiments of the present disclosure, the recommendation engine 185c may provide recommendations and suggestions based on various data inputs and algorithms, aiding in decision-making processes.

According to some embodiments of the present disclosure, the agent-dashboard may be a user interface where agents can view and manage interactions, access relevant information, and track performance metrics.

According to some embodiments of the present disclosure, inputs and reporting may be a component that collects data and insights from various modules and interactions, which is used to generate reports and analytics that provide valuable insights into performance and trends.

According to some embodiments of the present disclosure, the scheduling engine may handle scheduling and managing tasks, interactions, and agent availability to ensure optimal resource allocation and operational efficiency.

According to some embodiments of the present disclosure, the supervisor dashboard may be a user interface designed for supervisors and managers, providing insights into team performance, interaction trends, and key metrics to facilitate decision-making and monitoring.

According to some embodiments of the present disclosure, for example, when the social media feed contains hate speech or highly negative content about brand on the platform an action that may be taken by the supervisor dashboard based on the social-impact score may be monitoring the social-impact scores of these social-medias posts in real-time. If a social-media post receives a high negative social-impact score, indicating significant harm to the brand, the following actions may be triggered via the supervisor dashboard.

According to some embodiments of the present disclosure, for example, priority escalation. The ticket could be automatically escalated to a higher priority level, ensuring that it's addressed promptly by a senior customer service representative, or a specialized team trained to handle such sensitive issues.

According to some embodiments of the present disclosure, in another example, a trend analysis may be automatically initiated by the supervisor dashboard could aggregating social-impact scores over time to identify trends or patterns in harmful behavior on the platform. This data could then be used for proactive measures such as improving community guidelines, enhancing moderation algorithms, or implementing targeted user education campaigns by supervisor.

According to some embodiments of the present disclosure, in yet another example, the supervisor dashboard may automatically initiate training and feedback. High-impact social media posts could trigger by the supervisor dashboard targeted training sessions or coaching for the customer service representatives involved, helping them develop the skills and knowledge needed to handle similar situations more effectively in the future.

According to some embodiments of the present disclosure, in yet another example, the supervisor dashboard may automatically operate automatic responses and interventions. The supervisor dashboard could be integrated with automated response systems or moderation tools to initiate immediate actions such as removing offensive content, issuing warnings or bans to users, or deploying algorithmic filters to prevent similar incidents from occurring.

According to some embodiments of the present disclosure, in yet another example, the supervisor dashboard may automatically by leveraging the social-impact score through the supervisor dashboard, effectively prioritize the team efforts, mitigate risks, and uphold the platform's commitment to fostering a safe and positive online community.

According to some embodiments of the present disclosure, the ACQA 150c may calculate the social-impact score by operating a multi-step process that includes analyzing various parameters and combining them to determine the overall impact and priority of social media interactions.

According to some embodiments of the present disclosure, the ACQA 150c may collect data from social media platforms, which are integrated to the contact center. The data may include user profiles in the social-media platforms, social-media post content, engagement metrics such as, comments, shares, sentiment analysis, and any other relevant information. The user-profiles may be used by the ACQA 150c to calculate the content quality score.

According to some embodiments of the present disclosure, each parameter that is used to calculate the social-impact score of a social-media post, such as user reach, engagement metrics, relevance, accuracy, clarity, etc., may be quantified and standardized to ensure consistency and comparability across different interactions.

According to some embodiments of the present disclosure, weights may be assigned to each parameter based on its relative importance in determining the overall impact of social media interactions. These weights reflect the significance of each parameter in influencing the ASIS score, e.g., social-impact score.

According to some embodiments of the present disclosure, a score may be calculated for each parameter based on the data collected and the assigned weights. For example, the user reach score may be determined by the number of followers or connections, while the engagement metrics score may be calculated based on number of likes, comments, and number of shares of the social-media post.

According to some embodiments of the present disclosure, to ensure fairness and accuracy, the scores may be normalized to a standard scale or range, allowing for meaningful comparisons and aggregation of scores across different parameters.

According to some embodiments of the present disclosure, the scores for each parameter may be aggregated or combined using a predetermined formula or algorithm to derive the overall ASIS score for the social media interaction. This aggregation process may involve summing, averaging, or applying other mathematical operations to the parameter scores.

According to some embodiments of the present disclosure, for example, when the social-media post is: “I'm disappointed with the quality of the product I received. It doesn't match the description on the website. I'd like to request a refund or exchange.” The content quality analysis score:
UserReach: 7
engagement_metrics: 7
social_media_interaction_relevance: 10
social_media_post_accuracy: 8
social_media_post_clarity: 9
response_time_sensitivity: 6
Customer_emotion_intensity: 7
contextual_keywords: 7
customer_sentiment: 3
customer_feedback: 5
Weightage for each factor mentioned above: 0.1
Overall Content Quality Score: 8.7

### ASIS Calculation:

Total Content Quality score calculated in previous slide=8.7
Customer loyalty score (Organization proprietary Data)=6*1 (Weightage)=6

### Sum Up the ASIS Components:

Total ASIS=Total Content Quality Score+Customer Loyalty Score=8.7+6=14.7
Calculated overall AI-Powered Social Impact Score (ASIS)=14.7

According to some embodiments of the present disclosure, the social-impact score of each social-media post may be updated in real-time or periodically based on changes in interaction dynamics, content quality, customer sentiment, or other factors. This may ensure that the prioritization of social-media interactions remains responsive to evolving customer needs and market conditions.

According to some embodiments of the present disclosure, based on the social-impact score of the social-media posts, the social-media interactions may be prioritized for response or action. Higher ASIS scores may indicate greater importance or impact, which may result to prioritized handling by agents or automated systems.

According to some embodiments of the present disclosure, a feedback loop may be incorporated to continuously refine and improve the ASIS calculation process. Feedback from users, agents, or supervisors may be used to adjust weights, parameters, or scoring methodologies to better align with organizational goals and objectives.

According to some embodiments of the present disclosure, the social-impact score calculation may be a dynamic and iterative process that considers multiple factors to prioritize social media interactions effectively, ultimately leading to enhanced customer satisfaction, operational efficiency, and brand reputation.

FIG. 2 are a high-level workflow of a computerized-method for dynamically prioritizing social-media interactions in real-time, based on social-media posts in feeds, in a contact center, in accordance with some embodiments of the present disclosure.

According to some embodiments of the present disclosure, operation 210 comprising monitoring by one or more processors the social-media posts in the feeds of one or more social-media platforms which are integrated to the contact center. The social-media posts have been published during a preconfigured period; for each social-media post of a customer in each feed in the feeds: a. calculating a quality-score by operating an Artificial intelligence (AI) driven Content Quality Analysis (ACQA) module; and b. calculating a social-impact score based on the calculated quality score and one or more parameters.

According to some embodiments of the present disclosure, operation 220 comprising automatically prioritizing the social-media posts based on the calculated social-impact score to yield a priorities queue of social-media interactions. Each social-media post represents a social-media interaction.

According to some embodiments of the present disclosure, operation 230 comprising automatically routing social-media interactions by a routine-engine to an available agent based on the yielded priorities queue of social-media interactions.

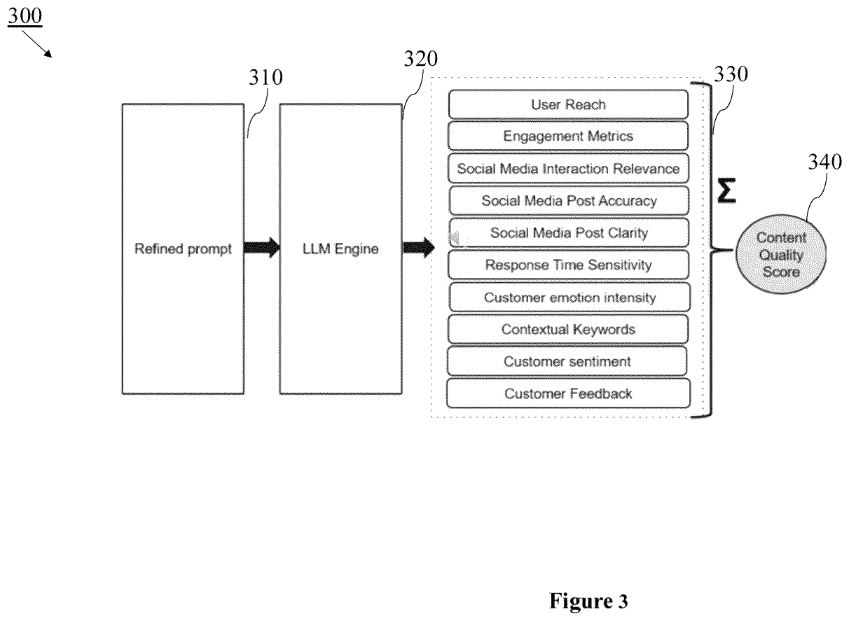

FIG. 3 is a diagram showing Artificial intelligence (AI) driven Content Quality Analysis (ACQA) module 300 and parameters for calculating a social-impact score based on the calculated quality score and the parameters, in accordance with some embodiments of the present disclosure.

According to some embodiments of the present disclosure, the ACQA module 300, such as ACQA module 150 in FIG. 1B and such as ACQA module 150c in FIG. 1C may construct a prompt 310 for LLM 320 to assess content quality. The prompt includes the text of the social-media post and instructions to assess various aspects of quality.

According to some embodiments of the present disclosure, the ACQA module 300 may send the constructed prompt to LLM 320 and retrieve the response. for example, it may be operated by using the OpenAI API.

According to some embodiments of the present disclosure, the ACQA module 300 may parse the response from the LLM to extract quality scores. The response is a string of text that includes the scores for each quality factor 330.

According to some embodiments of the present disclosure, the overall content quality score 340, e.g., social-impact score may be calculated by summing the quality-scores based on each quality-score preconfigured weight.

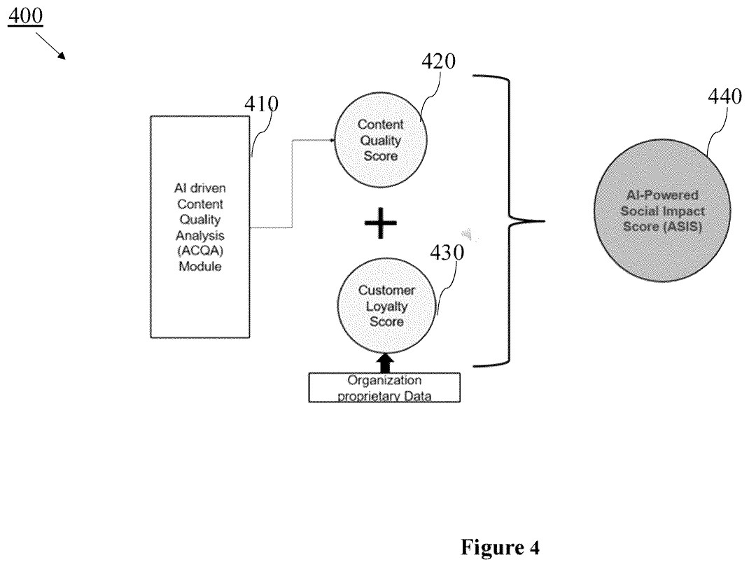

FIG. 4 is a diagram showing content quality score and customer loyalty score for calculating social-impact score, in accordance with some embodiments of the present disclosure.

According to some embodiments of the present disclosure, a quality-score, e.g., content quality score 410 may be calculated by a ACQA module 410, such as ACQA module 150 in FIG. 1B and such as ACQA module 150c in FIG. 1C and combined with a customer loyalty score 430 may yield a social-impact score, e.g., AI-powered Social Impact Score (ASIS) 440.

According to some embodiments of the present disclosure, the ASIS 440 may be a combination of content quality score 420 and customer loyalty score 430. The content quality score 420 may be an output of the ACQA module 410.

According to some embodiments of the present disclosure, the content quality score 420 may be generated by ACQA module 410, which may evaluate the quality of the content posted on social-media. The ACQA module 410 may assess factors, such as accuracy, relevance, clarity, and sentiment of the content. For example, as shown in FIG. 5. Each aspect or factor may be assigned a weight, and the scores may be aggregated to produce the content quality score 420.

According to some embodiments of the present disclosure, the customer loyalty score may reflect the loyalty and engagement level of the customer with the organization. It considers factors such as the duration of association with the company, frequency of interactions, and revenue contribution. The customer loyalty score 430 may provide insights into the customer's long-term value and relationship with the organization.

According to some embodiments of the present disclosure, the combination of the parameters, for example, as shown in FIG. 5, to determine the overall impact and priority of social-media interactions, e.g., social-media posts. Each parameter may be assigned a weight based on its importance in influencing the overall score.

According to some embodiments of the present disclosure, a dynamic prioritization of social-media posts may be implemented by incorporating the content quality score 420, customer loyalty score 430, and other parameters, and facilitating dynamic prioritization of digital interactions in real-time. High-priority interactions, characterized by high content quality and strong customer loyalty, may be prioritized, and responded to promptly, while lower-priority interactions receive appropriate attention based on their respective scores.

According to some embodiments of the present disclosure, the social-impact score may provide real-time adjustment by recalculating it periodically based on changes in interaction dynamics, content quality, and customer loyalty. This real-time adjustment ensures that the prioritization remains responsive to evolving customer needs and market conditions.

According to some embodiments of the present disclosure, real-time adjustment of the social-impact score involves periodically recalculating the score based on changes in various factors such as interaction dynamics, content quality, and customer loyalty. This ensures that the prioritization of social media posts remains responsive to evolving customer needs and market conditions. For example, if there is a sudden surge in customer inquiries or complaints on a particular topic, the interaction dynamics change, requiring a reevaluation of the social-impact score. Similarly, if the quality of content being posted by customers improves or declines, it can affect how posts are prioritized for response. Additionally, changes in customer loyalty, which may be influenced by factors such as recent interactions with the company or overall satisfaction levels, can also impact the social-impact score.

According to some embodiments of the present disclosure, by recalculating the social-impact score in real-time, contact centers can ensure that they are prioritizing social media posts effectively, addressing the most pressing issues or opportunities as they arise. This adaptive approach helps in providing timely and relevant responses to customers, ultimately enhancing their satisfaction and loyalty.

According to some embodiments of the present disclosure, in a scenario where a company launches a new product, and customers start posting about it on social media. Initially, the social-impact score for these posts might be relatively low, as there are only a few interactions and limited information about the product's quality or customer sentiment. However, as more customers engage with the posts, providing feedback and sharing their experiences, the interaction dynamics change. If the majority of interactions are positive, indicating high customer satisfaction with the new product, the social-impact score for related posts would increase in real-time. Conversely, if there are concerns or complaints raised by customers, the score might decrease or trigger a need for immediate attention from customer service agents. Additionally, if the company monitors customer loyalty metrics and notices a decline in loyalty among certain segments of customers, the social-impact score could be adjusted accordingly to prioritize posts from these customers for personalized responses or interventions.

According to some embodiments of the present disclosure, by continuously recalculating the social-impact score based on evolving factors, the contact center can effectively prioritize social media interactions, ensuring timely and impactful responses that address customer needs and contribute to overall customer satisfaction and loyalty.

FIG. 5 is a diagram showing interaction management factors 500, in accordance with some embodiments of the present disclosure.

According to some embodiments of the present disclosure, the user reach parameter measures the reach or influence of the user who posted the content on social-media post. It considers metrics such as, the number of followers, friends, or connections the user has on the platform. A higher user reach indicates a wider audience potentially impacted by the social-media post.

According to some embodiments of the present disclosure, for example, if the number of followers on Instagram are greater than 10,000 then UserReach parameter value will be greater than 9. If number of followers on Instagram are between 5,000 to 10,000 then UserReach parameter value will be between 7 to 9. If number of followers on Instagram are between 1,000 to 5,000 then UserReach parameter value will be between 5 to 7. If number of followers on Instagram are lesser than 1,000 then UserReach parameter value will be lesser than 5.

According to some embodiments of the present disclosure, the engagement metrics parameter assesses the level of interaction or engagement generated by the social-media post. This includes metrics such as likes, comments, shares, and click-through rates. Higher engagement metrics suggest that the post has captured the attention and interest of the audience.

According to some embodiments of the present disclosure, for example, the calculation of the engagement metrics for the social-media post when the media-post is:
“Excited to announce our latest product launch! Check out our website for more details.”

### Engagement Metrics:

Likes: 50
Comments: 20
Shares: 15
Click-through Rate: 10%.
   To calculate the engagement metrics score, weights may be assigned to each metric based on its importance in determining overall engagement. the following weights may be assigned:
Likes: 0.4
Comments: 0.3
Shares: 0.2
Click-through Rate: 0.1.
the score calculation for each metric:

$$Likes Score = 50 * 0.4 = 20$$

$$Comments Score = 20 * 0.3 = 6$$

$$Shares Score = 15 * 0.2 = 3$$

$$Click - through Rate Score = 10 \% * 0.1 = 1$$

Then, sum up the scores for all metrics to get the total engagement metrics score: Total Engagement Metrics Score=(Likes Score+Comments Score+Shares Score+Click-through Rate Score Total Engagement Metrics Score)*Normalization_Weight=(20+6+3+1)*0.1=3
So, for this social media post, the engagement metrics score is 3. Higher engagement metrics suggest that the post has captured the attention and interest of the audience effectively.

According to some embodiments of the present disclosure, the social media interaction relevance parameter evaluates the relevance of the social-media interaction to the objectives and goals of the contact center. It assesses whether the social-media post is related to addressing customer concerns, inquiries, or complaints. Relevant interactions are more likely to be prioritized for response by an available agent.

According to some embodiments of the present disclosure,
Example Social Media Post: “I'm having trouble with the new update. It keeps crashing whenever I try to open it.”
To assess the relevance of this social media interaction, we'll consider the following factors:
1. Does the post address a customer concern, inquiry, or complaint?
   (1)
Yes, the post indicates that the user is experiencing technical issues with the new update, which can be categorized as a customer concern or complaint.
1. Is the content of the post aligned with the objectives and goals of the contact center?
   (1)
(1) Yes, the contact center's goal is to address customer concerns and provide support for technical issues related to their products or services.

Based on these considerations, we can assign a relevance score to the social media interaction. Let's use a scoring system from 1 to 10, where:
1: Not relevant
2-3: Low relevance
4-6: Moderate relevance
7-8: High relevance
9-10: Very high relevance
Given that the social-media post directly addresses a customer concern related to product functionality and aligns with the goals of the contact center, we can assign a relevance score of 8 (High relevance).
So, for this example, the social-media interaction relevance parameter score is 8, indicating that the post is highly relevant to the objectives and goals of the contact center and should be prioritized for response by an available agent.

According to some embodiments of the present disclosure, the social media post accuracy parameter refers to the factual correctness and specificity of the information presented in the social-media post. Accurate posts provide reliable information to users, contributing to trust and credibility.

According to some embodiments of the present disclosure, for example, if the information presented in the social media post is factually correct, specific, and provides reliable information, then the SocialMediaPostAccuracy parameter value will be high. Conversely, if the information is vague, misleading, or contains factual inaccuracies, the parameter value will be lower.

According to some embodiments of the present disclosure, if the social media post provides detailed information, backed by sources or evidence, and is aligned with known facts, then the accuracy parameter value will be high, such as 8 or above on a scale of 1 to 10. If the post contains general statements without specific details or lacks credibility, the accuracy parameter value might be moderate, ranging from 5 to 7. If the post contains misinformation, inaccuracies, or lacks specificity, the accuracy parameter value will be low, such as below 5. This approach allows for quantifying the accuracy and specificity of the information presented in social-media posts, contributing to the overall trustworthiness and credibility of the content shared on social platforms.

According to some embodiments of the present disclosure, the social media post clarity parameter assesses the readability and comprehensibility of the language used in the social media post. Clear and concise communication ensures that the message is easily understood by the audience, enhancing engagement and effectiveness.

According to some embodiments of the present disclosure, for example, if the language used in the social media post is clear, concise, and easily understandable, then the SocialMediaPostClarity parameter value will be high. Conversely, if the language is convoluted, verbose, or difficult to understand, the parameter value will be lower.

According to some embodiments of the present disclosure, if the social media post uses simple language, avoids jargon or complex terminology, and communicates the message clearly, the clarity parameter value will be high, such as 8 or above on a scale of 1 to 10. If the post contains complex sentences, unclear phrasing, or ambiguous language, the clarity parameter value might be moderate, ranging from 5 to 7. If the post is difficult to understand, uses technical language without explanation, or lacks coherence, the clarity parameter value will be low, such as below 5.

This approach allows for quantifying the readability and comprehensibility of the language used in social media posts, ensuring that messages are effectively communicated to the audience, leading to higher engagement, and understanding.

According to some embodiments of the present disclosure, the response time sensitivity parameter considers the urgency or sensitivity of the content of the social-media post that is requiring a response. Certain social-media posts may necessitate immediate attention and timely responses, while others may have less stringent response time requirements.

According to some embodiments of the present disclosure, for example: if the content of the social media post requires an immediate response due to its urgency or sensitivity, then the ResponseTimeSensitivity parameter value will be high. Conversely, if the post is less urgent and can be responded to within a longer timeframe, the parameter value will be lower.

According to some embodiments of the present disclosure, if the social media post is related to an emergency situation, such as a customer reporting a safety concern or requesting urgent assistance, the response time sensitivity parameter value will be high, such as 8 or above on a scale of 1 to 10. If the post is a general inquiry or feedback that does not require an immediate response but should still be addressed promptly, the sensitivity parameter value might be moderate, ranging from 5 to 7. If the post is informational or non-urgent in nature, such as a customer sharing a positive experience or asking a non-time-sensitive question, the sensitivity parameter value will be low, such as below 5. This approach allows for quantifying the urgency and sensitivity of the content of social media posts, helping contact centers prioritize their responses accordingly and ensure timely and appropriate engagement with customers.

According to some embodiments of the present disclosure, the customer emotion intensity parameter evaluates the intensity or strength of emotions expressed in the social media post. It considers emotions such as satisfaction, frustration, anger, joy, or disappointment. Social-media posts with high emotion intensity may require sensitive handling and personalized responses.

According to some embodiments of the present disclosure, the contextual keywords parameter analyzes the presence of specific keywords or phrases relevant to the domain or industry of the contact center. These keywords indicate the subject matter or context of the post and help determine its relevance and importance.

According to some embodiments of the present disclosure, the contextual keywords parameter plays a crucial role in analyzing the relevance and importance of social media posts within the context of the contact center's domain or industry.

According to some embodiments of the present disclosure, the analysis of contextual keywords may operate as follows: initially, specific keywords may be identified or phrases that are relevant to the domain or industry of the contact center. These keywords can include product names, service offerings, industry terms, or any other terms that are commonly associated with the organization's area of expertise.

According to some embodiments of the present disclosure, the analysis may examine whether these contextual keywords are present in the social media post. This involves scanning the text of the post to identify occurrences of the keywords and assess their frequency and prominence.

According to some embodiments of the present disclosure, once the presence of contextual keywords is determined, the analysis evaluates the relevance of these keywords to the content of the post. This involves considering the context in which the keywords are used and assessing whether they contribute to the overall subject matter or theme of the post.

According to some embodiments of the present disclosure, finally, based on the presence and relevance of contextual keywords, the analysis assigns importance to the post. Posts that contain relevant contextual keywords are deemed more important and may be prioritized for response or further action by the contact center.

According to some embodiments of the present disclosure, for example, when a contact center for a technology company receiving social-media posts related to a new product launch. Contextual keywords, such as the product name, key features, and related terms would indicate the relevance of the posts to the company's domain. Posts that contain these keywords prominently and in a relevant context would be considered more important and may require immediate attention or response from the contact center.

According to some embodiments of the present disclosure, by analyzing contextual keywords, contact centers can effectively gauge the relevance and importance of social media posts within their domain, enabling them to prioritize responses and engage with customers in a timely and relevant manner.

According to some embodiments of the present disclosure, the customer sentiment parameter provides a sentiment analysis which assesses the overall sentiment or tone of the social media post, whether positive, negative, or neutral. Understanding customer sentiment helps gauge the customer's mood, satisfaction level, and potential impact on brand perception. The sentiment analysis may be operated by using sentiment analysis libraries or APIs such as Natural Language Toolkit (NLTK), TextBlob, IBM Watson Natural Language Understanding, to analyze the sentiment of the social-media post content.

According to some embodiments of the present disclosure, the customer loyalty parameter measures the loyalty and long-term relationship of the customer with the organization. It considers factors such as the duration of association, frequency of interactions, and revenue contribution. Loyal customers may receive special attention or higher priority in engagement.

According to some embodiments of the present disclosure, the customer feedback parameter captures the responses, comments, or feedback provided by customers in response to the social-media post. Customer feedback analysis provides insights into customer satisfaction, concerns, and preferences, which can inform future engagement strategies and actions.

According to some embodiments of the present disclosure, for example, for the following social-media post: “We've launched our new product line! Tell us what you think in the comments below.”
The customer feedback analysis may be:
Positive Feedback: 30 comments expressing satisfaction and excitement.
Negative Feedback: 10 comments highlighting concerns or dissatisfaction.
Neutral Feedback: 15 comments providing constructive criticism or suggestions.
Aassign scores to each category based on the volume and sentiment of the comments:
Positive Feedback Score: 30*0.4=12
Negative Feedback Score: 10*0.4=4
Neutral Feedback Score: 15*0.2=3
Sum up the scores for each category to get the total customer feedback score: Total Customer Feedback Score=(Positive Feedback Score+Negative Feedback Score+Neutral Feedback Score Total Customer Feedback Score)*Normalized_Weight=(12+4+3)*0.1=1.9
So, for this social media post, the total customer feedback score is 1.9. This score provides insights into the overall sentiment and engagement level of customers with the new product line launch.

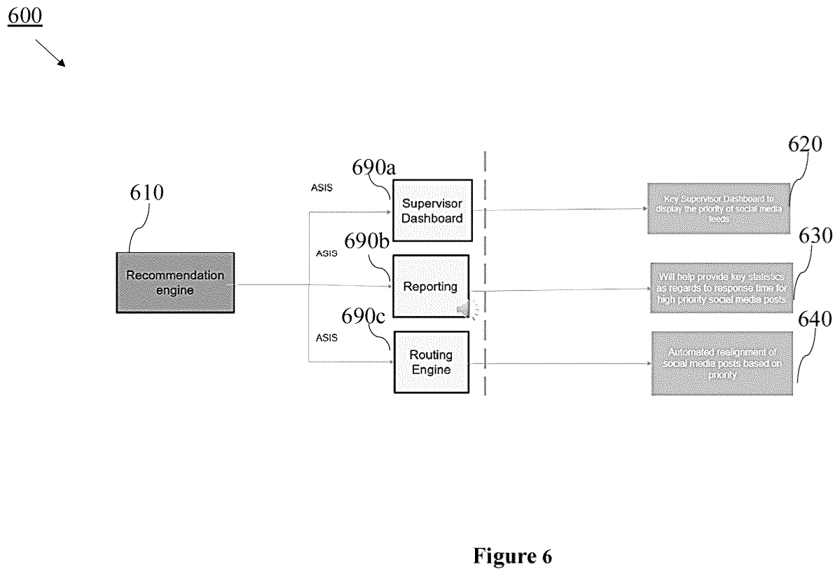

FIG. 6 is a high-level workflow of a recommendation engine 600, in accordance with some embodiments of the present disclosure.

According to some embodiments of the present disclosure, a recommendation engine 610, such as recommendation engine 185c in FIG. 1C, may send the social-impact score of the social-media post to a supervisor dashboard 690a, reporting 690b and a routing engine 690c. The social-media posts may be automatically prioritized based on the calculated social-impact score to yield a priorities queue of social-media interactions, the routing engine 690c, such as routing engine 140b in FIG. 1B may automatically route social-media interactions by a routine-engine to an available agent based on the yielded priorities queue of social-media interactions.

According to some embodiments of the present disclosure, a routing strategy encompassing “push” and “inbox” concepts for digital routing may be implemented in a system, such as system 100B in FIG. 1B. Social-media posts will undergo periodic prioritization and re-prioritization based on the ASIS score, e.g., social-impact score calculation. This will serve as a valuable addition, particularly for social media posts that often have high volumes and require a system for consistent and incremental prioritization.

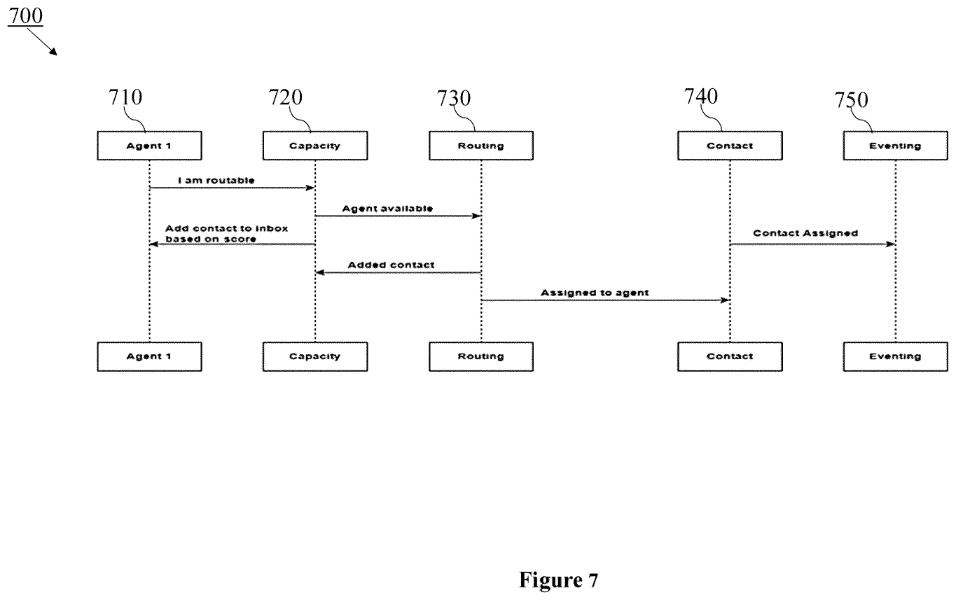

FIG. 7 is a diagram showing routing interactions using the social-impact score, in accordance with some embodiments of the present disclosure.

According to some embodiments of the present disclosure, for each agent 710 in the contact center, when agent slot is available the capacity 720 is updated accordingly and forwarded to a routing engine, such as routing engine 140 in FIG. 1B. The routing 730 may be for example, an Automated Call Distribution (ACD) application.

According to some embodiments of the present disclosure, the social-impact score may be calculated at predefined time-intervals. For the available agent 710, the routing 730 may select a social-media post having highest social-impact score. The contact related to the social-media post having the highest social-impact score may be assigned 750 to the available agent 710.

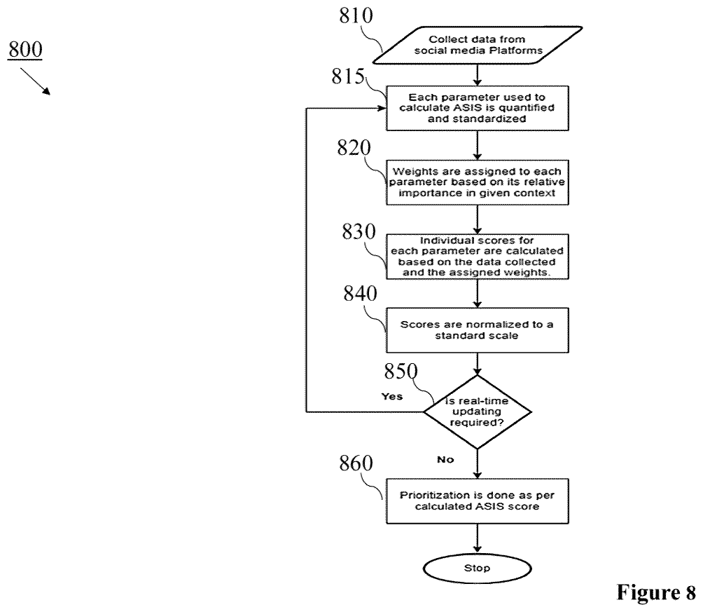

FIG. 8 is a high-level workflow 800 for dynamically prioritizing social-media interactions in real-time, based on social-media posts in feeds, in accordance with some embodiments of the present disclosure.

According to some embodiments of the present disclosure, collecting data from social-media platforms 810 may be operated by APIs of the social-media platforms which are integrated to the contact center. The APIs may be used to collect data as to the contact of the social-media post, e.g., user-profiles, the social-media content and engagement metrics such as number of likes, number of shares and related comments. For example, the APS of the social-media platforms may be Facebook Graph API, Twitter API and the like.

According to some embodiments of the present disclosure, sentiment analysis may be operated by using sentiment analysis libraries or APIs such as Natural Language Toolkit (NLTK), TextBlob, IBM Watson Natural Language Understanding, to analyze the sentiment of the social-media post content. The collected data may be stored in a database, such as MySQL, and PostgreSQL, for further processing.

According to some embodiments of the present disclosure, each parameter used to calculate ASIS, e.g., social-impact score, is quantified and standardized 815. The parameters may be for example the parameters in FIG. 5. Algorithms may be implemented to quantify and standardize each parameter to ensure uniformity and comparability across interactions. For example, normalize engagement metrics to a common scale.

According to some embodiments of the present disclosure, weights are assigned to each parameter based on its relative importance in given context 820. The weights may be assigned to each parameter based on its relative significance in determining the overall social-impact score of the social-media post. These weights can be predefined based on domain knowledge or adjusted dynamically based on feedback.

According to some embodiments of the present disclosure, a configuration mechanism may be implemented in a system such as system 100B in FIG. 1B and such as system 100C in FIG. 1C to allow customization of parameter weights.

According to some embodiments of the present disclosure, individual scores for each parameter are calculated based on the data collected and the assigned weights 830. The score for each parameter may be calculated by algorithms which were developed to compute individual scores for each parameter using the collected data and assigned weights. For example, for user reach, the score, may be calculated based on the number of followers or connections using a weighted formula.

According to some embodiments of the present disclosure, scores are normalized to a standard scale 840. Functions may be created to normalize scores to a standardized scale or range. This ensures fairness and precision in comparisons across parameters. For example, min-max scaling may be implemented or z-score normalization techniques for the normalization.

According to some embodiments of the present disclosure, an aggregation logic may be developed to aggregate scores for each parameter to derive the overall social-impact score for the social media interaction. For example, aggregate parameter scores using a weighted sum, or another mathematical operation based on predefined formulas.

According to some embodiments of the present disclosure, checking is real-time updating required 850 after a predefined time-interval. An event-driven architecture may be implemented to trigger updates to ASIS scores in real-time based on changes in interaction dynamics, content quality, and customer sentiment.

According to some embodiments of the present disclosure, streaming data processing frameworks such as Apache Kafka, Apache Flink, may be utilized to process incoming data and update ASIS scores, e.g., social-impact score dynamically.

According to some embodiments of the present disclosure, prioritization is done as per calculated ASIS score 860. A decision logic may be developed to prioritize social media interactions for response or action based on the calculated ASIS scores. Thresholds may be set for prioritization based on ASIS scores, with higher scores indicating greater importance or impact.

According to some embodiments of the present disclosure, for example, suppose a contact center has implemented a decision logic for prioritizing social media interactions based on their ASIS scores. The decision logic includes predefined thresholds for different levels of prioritization.

### Thresholds:

High Priority: ASIS score greater than or equal to 8.5
2. Medium Priority: ASIS score between 6.0 and 8.5
3. Low Priority: ASIS score less than 6.0

### Scenario: Consider Three Social Media Posts Received by the Contact Center:

### Post 1:

ASIS Score: 9.2
Priority: High (ASIS score meets or exceeds the threshold for high priority)

### Post 2:

ASIS Score: 7.3
Priority: Medium (ASIS score falls within the range for medium priority)

### Post 3:

ASIS Score: 5.5
Priority: Low (ASIS score does not meet the threshold for medium priority)
Post 1: with an ASIS score of 9.2, this post meets the threshold for high priority, indicating its significant importance or impact. It would be prioritized for an immediate response or action by customer service agents.
Post 2: although the ASIS score of 7.3 is lower than that of Post 1, it still falls within the range for medium priority. This suggests that the post is of moderate importance or impact and should be addressed promptly but may not require immediate attention.
Post 3: with an ASIS score of 5.5, this post does not meet the threshold for medium priority. It is categorized as low priority, indicating that it can be addressed at a later time or may not require a response from customer service agents.
By using predefined thresholds based on ASIS scores, the contact center may prioritize social media interactions for response or action, ensuring that resources are allocated efficiently, and critical issues are addressed in a timely manner.

According to some embodiments of the present disclosure, a feedback mechanism may be implemented to gather feedback from users, agents, or supervisors. The feedback may be utilized to iteratively refine and enhance the ASIS calculation process by adjusting weights, parameters, or scoring methodologies.

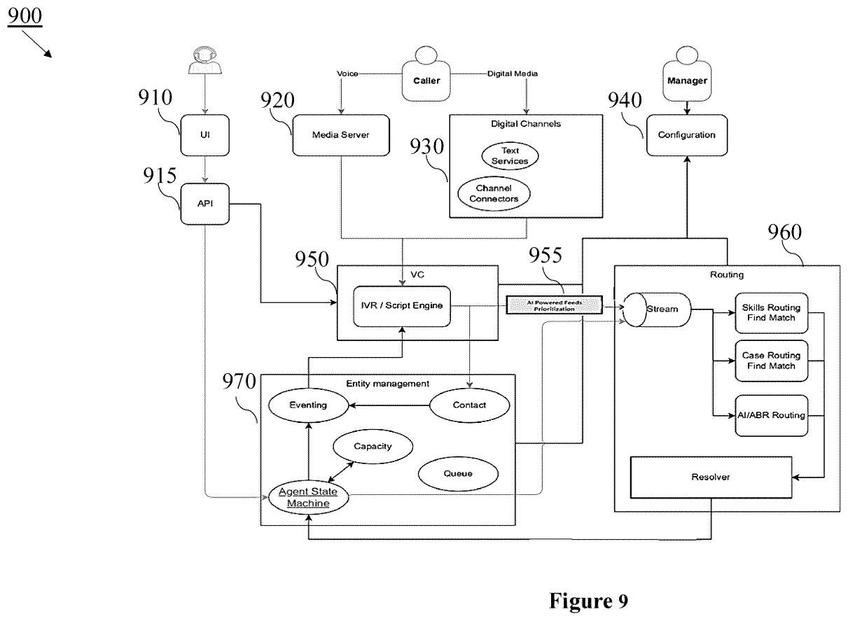

FIG. 9 is a diagram for a system 900 for dynamically prioritizing social-media interactions in real-time, based on social-media posts in feeds, in accordance with some embodiments of the present disclosure.

According to some embodiments of the present disclosure, system 900 may include similar component as system 100B in FIG. 1B.

According to some embodiments of the present disclosure, in system 900 an AI Powered feed prioritization may ensure the interaction in queue are prioritization appropriately based on the calculated social-impact score to ensure most relevant and prioritized interactions are at the top. These prioritized interactions may be streamed into a queue, such as priorities queue of social-media interactions 160 in FIG. 1B, which is then diverted to an adequate routing technique, such as, skill-based routing, case routing find match.

According to some embodiments of the present disclosure, a caller, which may be a customer communicating with the contact center via digital channels 930 such as text services or channel connectors e.g., social-media post may also communicate via voice-calls via a media server 920.

According to some embodiments of the present disclosure, a manager 940 may be a contact center entity who keeps tab on contact center interactions and managers agents.

According to some embodiments of the present disclosure, the digital channels 930 enable customers to engage with contact centers through electronic means, such as email, web chat, social media, messaging applications, and self-service portals. These channels provide additional options for customers to seek assistance, resolve issues, or obtain information, offering convenience and flexibility in communication.

According to some embodiments of the present disclosure, an Interactive Voice Response/script engine 950, may include IVR prompts which are available for customers to navigate through various options. Through IVR initial interaction with customer is scripted understanding in the process explicit query customer had. A customer may use UI 910 which via the API 915 may operate the IVR/Script Engine in the Voice Control (VC) 950.

According to some embodiments of the present disclosure, entity management 970 may handle working with agent state machine to find best possible agent based available.

According to some embodiments of the present disclosure, the AI powered feeds prioritization 955, such as dynamic prioritization of social-media interactions in real-time, based on social-media posts in feeds module 120 in FIG. 1B may ensure that the interactions to be addressed are queued for resolution in line with the dynamic prioritization and not static prioritization.

According to some embodiments of the present disclosure, routing 960, such as routing engine 140 in FIG. 1B may include resolving interactions based on dynamic prioritization of interactions. Various existing routing algorithms may be implemented, such as skill routing find match, case routing. This will ensure routing is done appropriately based on the dynamic prioritization.

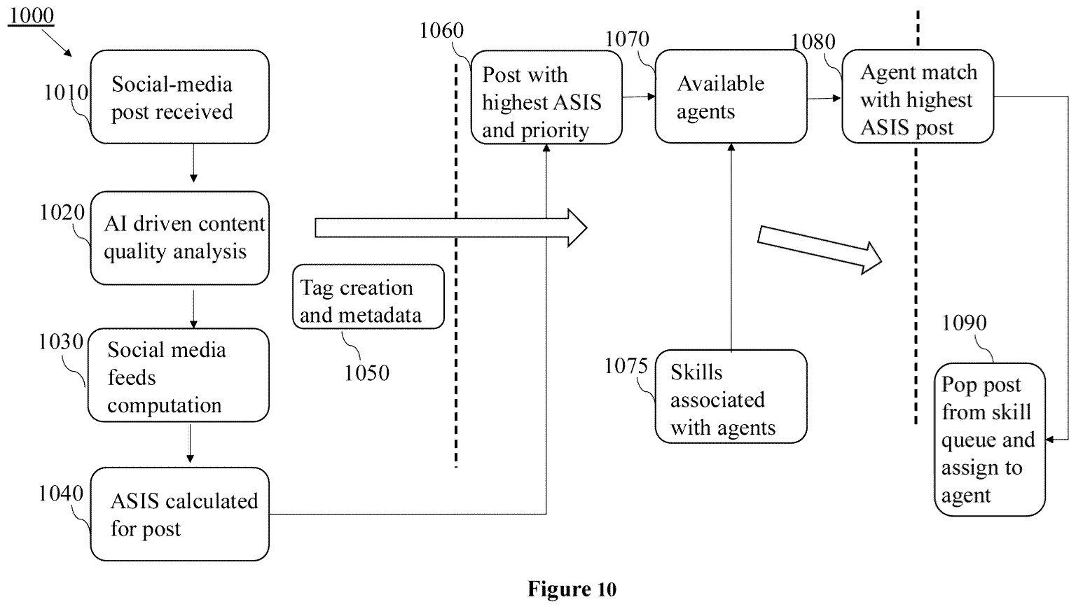

FIG. 10 is a high-level workflow for selecting a suitable agent to response to a social-media post, in accordance with some embodiments of the present disclosure.

According to some embodiments of the present disclosure, in a system, such as system 100B in FIG. 1B, when a social-media post received 1010 in a social-media platform integrated to the contact center, a content quality score may be calculated to the social-media post by an AI driven content quality analysis 1020, such as ACQA module 150 in FIG. 1B.

According to some embodiments of the present disclosure, the ACQA module may include data collection of social media posts, which may include text, images, videos, or a combination thereof. It may utilize APIs provided by social media platforms to fetch posts or may receive posts from another component in the system.

According to some embodiments of the present disclosure, if the input is text-based, the ACQA module may operate preprocessing steps such as tokenization, lowercasing, punctuation removal, and stop-word removal may be applied to clean the text data. For non-textual content like images or videos, preprocessing steps such as resizing, normalization, and feature extraction may be performed. Stop words are words that appear frequently in a language but contribute little to the overall context or semantics of a sentence. For example, prepositions, such as “in,” “on,” “at”, conjunctions, such as, “and,” “but,” “or”, articles such as, “the,” “a,” “an”, and pronouns such as, “I,” “you,” “he,” “she”.

According to some embodiments of the present disclosure, the ACQA module may extract features from text data, such as word frequency, Term Frequency-Inverse Document Frequency (TF-IDF), word embeddings, e.g., Word2Vec, GloVe, or contextual embeddings, e.g., Bidirectional Encoder Representations from Transformers (BERT), GPT. The ACQA module may extract visual features from images or videos using techniques like Convolutional Neural Networks (CNNs) or pre-trained models, such as Visual Geometry Group (VGG), ResNet.

According to some embodiments of the present disclosure, the ACQA module may operate text analysis by analyzing text content for various quality aspects such as relevance, accuracy, clarity, sentiment, and language fluency. Techniques like Natural Language Processing (NLP), sentiment analysis, and readability analysis may be applied. Image/video analysis may be operated by analyzing visual content for quality aspects such as relevance, clarity, and appropriateness. This may involve object detection, image classification, and content moderation techniques.

According to some embodiments of the present disclosure, parameters may be defined for assessing content quality, such as relevance, accuracy, clarity, sentiment, and overall quality. A score may be assigned to each parameter based on the analysis results. These scores may be numerical values representing the degree of adherence to quality standards.

According to some embodiments of the present disclosure, individual quality scores may be combined into an overall content quality score. This aggregation may involve weighted averaging or other mathematical operations based on predefined formulas. The overall quality score may be normalized to a standardized scale or range to ensure comparability across different content types.

According to some embodiments of the present disclosure, the computed quality scores along with detailed insights may be provided into various quality aspects of the content. The quality assessment results may be integrated with other modules or components in the system, such as the ASIS calculation module 1040 or the social media feeds computation module 1030.

According to some embodiments of the present disclosure, the AI models, used in the ACQA module, may be trained using labeled data to improve accuracy and performance.

According to some embodiments of the present disclosure, mechanisms for continuous learning and model updates to adapt to evolving content types and quality standards over time may be implemented for continuous learning.

According to some embodiments of the present disclosure, the social media feed computation 1030 may be a developed secure API to fetch customer loyalty score from organization's proprietary database for the social-media post.

According to some embodiments of the present disclosure, the ASIS calculated for post 1040 may be operated by summation of scores received from the ACQA module 1020 and social media feeds computation 1030 to calculate the final ASIS score.

According to some embodiments of the present disclosure, in the context of the ASIS calculation process, tag creation and metadata likely play roles in enhancing the accuracy and effectiveness of the scoring system. Tags may be created for posts based on their content quality, relevance, urgency, sentiment, or other factors relevant to the ASIS calculation. These tags help identify the key attributes of the posts that contribute to their impact and influence on customer satisfaction and operational efficiency.

According to some embodiments of the present disclosure, metadata associated with social media posts, such as engagement metrics, user reach, response time sensitivity, and contextual keywords, provide valuable information that informs the ASIS calculation. By analyzing this metadata alongside the content of the posts, the ASIS system can accurately assess their overall impact and prioritize them accordingly.

According to some embodiments of the present disclosure, tag creation and metadata play essential roles in organizing and contextualizing social media posts within the ASIS calculation framework, enabling more accurate and effective assessment of their impact on customer satisfaction and operational efficiency. For example, suppose a contact center utilizes the ASIS calculation system to prioritize social media posts for response. For example, the following social-media post on Twitter:

“Disappointed with my recent purchase from XYZ Company. Product arrived damaged, and customer service has been unresponsive. #CustomerServiceFail”
Metadata:
Date and Time of Post: Jun. 15, 2024, 10:30 AM
Author: @User123
Platform: Twitter
Number of Likes: 10
Number of Retweets: 5
Hashtags: #CustomerServiceFail

According to some embodiments of the present disclosure, tag creation: this post may be tagged as having low content quality due to the negative sentiment expressed and the issue with the product. Given the nature of the complaint and the use of hashtags like #CustomerServiceFail, this post may be tagged as requiring immediate attention. The sentiment of this post is negative, indicating dissatisfaction with the company's product and customer service. Since the post contains feedback about a recent purchase experience, it may be tagged as customer feedback for further analysis.

According to some embodiments of the present disclosure, the ASIS calculation system would consider the metadata and tags associated with the post, along with other factors such as user reach and engagement metrics. It would then use these inputs to calculate the overall ASIS score, which would help prioritize the post for response by customer service agents. In this example, tag creation and metadata play critical roles in contextualizing the social media post and informing its prioritization within the ASIS calculation system. They provide valuable insights into the content, sentiment, urgency, and relevance of the post, enabling the contact center to effectively address customer concerns and improve overall customer satisfaction.

According to some embodiments of the present disclosure, the post with highest ASIS and priority 1060 may be forwarded to a routing engine having a routing distributor which is sorting the interactions as per their ASIS score in descending order i.e., interaction with the highest ASIS score will be prioritized over others.

According to some embodiments of the present disclosure, by using advanced FindMatch mechanism getting the available agents 1070 with the skillset required 1075 to handle the social-media post.

According to some embodiments of the present disclosure, agent match with highest ASIS post may be selected by a match selector mechanism, that handles how a list of matching agents get narrowed down to a single match.

According to some embodiments of the present disclosure, pop post from skill queue and assign to agent 1090 may be operated by mechanisms, such as, Outbound Routing Matching Engine, Preferred List Matching Engine to assign an interaction to the agent.

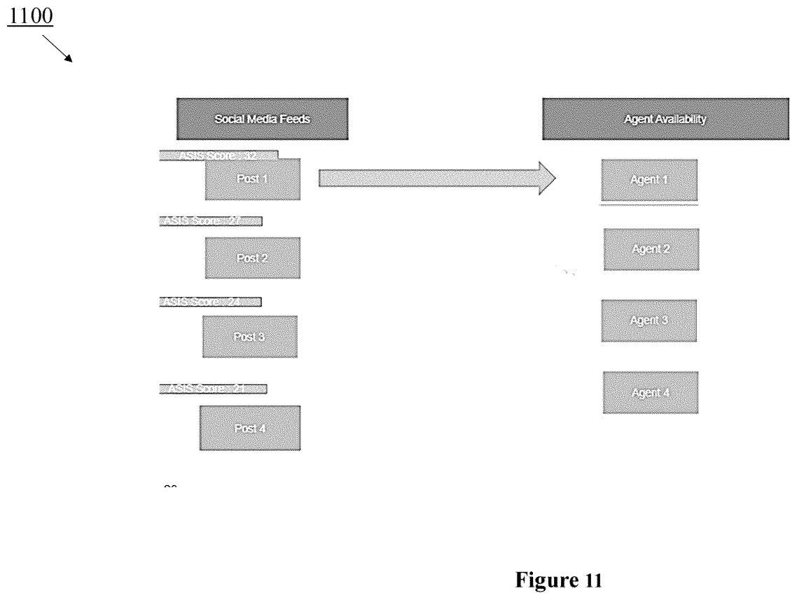

FIG. 11 is a high-level workflow 1100 for selecting an agent having highest social-impact score to response to a social-media post, in accordance with some embodiments of the present disclosure.

According to some embodiments of the present disclosure, in a system, such as system 100B in FIG. 1B, the interaction with highest ASIS score is on the top and will be assigned to a skilled agent appropriately. Thus, it may ensure that interactions are dynamically prioritized.

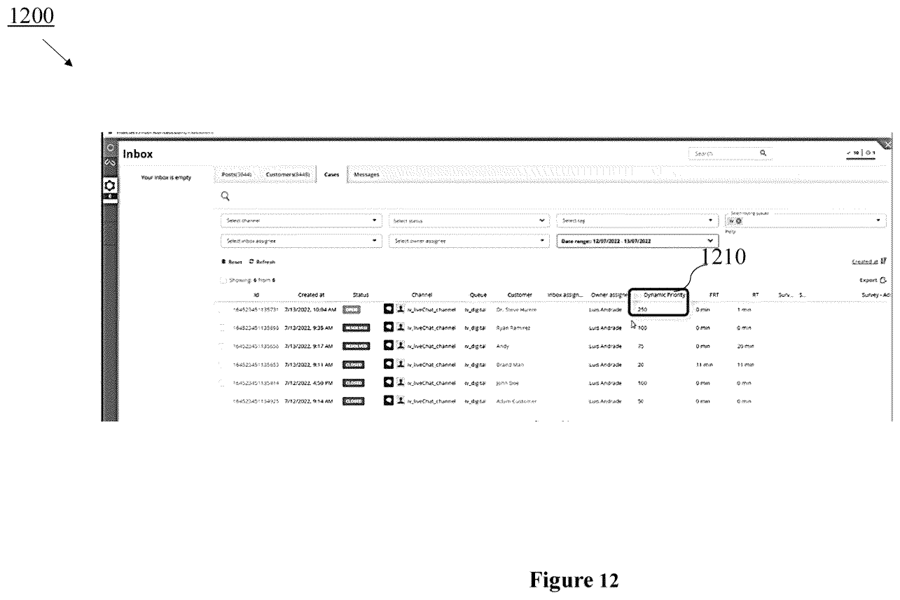

FIG. 12 is a screenshot of a UI 1200 for dynamically prioritizing social-media interactions in real-time, based on social-media posts in feeds, in a contact center, in accordance with some embodiments of the present disclosure.

According to some embodiments of the present disclosure, UI 1200 shows dynamic prioritization of interactions ensuring that always high priority interaction. In the screenshot of the UI 1200 the corresponding chat channel, queue type e.g., digital, customer, agent to whom interaction is assigned and corresponding dynamic priority is presented.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for dynamically prioritizing social-media interactions in real-time, based on social-media posts in feeds, in a contact center, said computerized-method comprising:
(i) monitoring by one or more processors the social-media posts in the feeds of one or more social-media platforms which are integrated to the contact center,
wherein said social-media posts have been published during a preconfigured period, for each social-media post of a customer in each feed in the feeds:
a. calculating a quality-score by operating an Artificial intelligence (AI) driven Content Quality Analysis (ACQA) module; and
b. calculating a social-impact score based on the calculated quality score and one or more parameters;
(ii) automatically prioritizing the social-media posts based on the calculated social-impact score to yield a priorities queue of social-media interactions,
wherein each social-media post represents a social-media interaction, and
(iii) automatically routing social-media interactions by a routine-engine to an available agent based on the yielded priorities queue of social-media interactions.

2. The computerized-method of claim 1, wherein said ACQA module comprising:
(i) preprocessing text and media elements in the social-media post;
(ii) analyzing the preprocessed text and the preprocessed media elements to yield one or more factors of quality;
(iii) constructing a prompt for Large Language Model (LLM),
wherein the prompt includes the text of the post and instructions to assess the one or more factors of quality;
(iv) sending the constructed prompt to be executed via an Application Programming Interface (API) platform of the LLM and receiving a response;
(v) parsing the response to extract one or more quality-scores,
wherein the response is a string of text that includes a quality-score for each quality factor in the one or more factors of quality; and
(vi) calculating a total-content quality score, by summing the one or more quality-scores based on each quality-score preconfigured weight.

3. The computerized-method of claim 2, wherein said one or more factors of quality includes at least one of: (i) relevance; (ii) accuracy; (iii) clarity; (iv) sentiment; and (v) total-quality.

4. The computerized-method of claim 1, wherein said one or more parameters comprising at least one of:
(i) user reach;
(ii) engagement metrics;
(iii) social-media post relevance;
(iv) social-media post accuracy;
(v) social-media post clarity;
(vi) response time sensitivity;
(vii) customer emotion intensity;
(viii) contextual keywords;
(ix) customer sentiment;
(x) customer loyalty; and
(xi) customer feedback.

5. The computerized-method of claim 4, wherein said customer loyalty parameter of the customer is retrieved by the computerized-method further comprising: operating a social-media-feeds computation module, said social-media-feeds computation module comprising:
retrieving the customer loyalty parameter of the customer, from a customers-database, and wherein the computerized-method further comprising:
a. constructing a social-impact-prompt LLM, that includes the text of the social-media post and
b. instructions to assess at least one parameter of: (i) user reach; (ii) engagement metrics; (iii) social-media post relevance; (iv) social-media post accuracy; (v) social-media post clarity; (vi) response time sensitivity; (vii) customer emotion intensity; (viii) contextual keywords; (ix) customer sentiment; and (x) customer feedback; and b. sending the constructed social-impact-prompt to be executed via an API platform of the LLM and receiving a response that includes a score for each parameter.

6. The computerized-method of claim 1, wherein said processing of the text includes at least one of: (i) tokenizing; (ii) lowercasing; (iii) removing punctuation and stop-word; (iv) text-feature extraction,
wherein said text-feature extraction includes at least one of: (i) word frequency; (ii) Term Frequency-Inverse Document Frequency (TF-IDF); (iii) word embeddings; and (iv) contextual embeddings.

7. The computerized-method of claim 2, wherein said processing media elements includes at least one of: (i) resizing; (ii) normalization; and (iii) visual-feature extraction, wherein said visual-feature extraction is operated by at least one of: (i) Convolutional Neural Networks (CNNs); and (ii) pretrained models.

8. The computerized-method of claim 2, wherein said analyzing of the preprocessed text is performed by applying at least one of: (i) Natural Language Processing (NLP); (ii) sentiment analysis; and (iii) readability analysis, and
wherein said analyzing of the preprocessed media elements is operated by visual content analysis, said visual content analysis includes at least one technique of: (i) object detections; (ii) image classification; and (iii) content moderation.

9. The computerized-method of claim 1, wherein said computerized-method is further comprising normalizing the calculated total-content quality score to a standardized scale.

10. The computerized-method of claim 2, wherein said LLM is continuously trained using labeled data updates to adapt to evolving content types and quality standards over time.

11. The computerized-method of claim 1, wherein said computerized-method is further comprising forwarding the calculated social-impact score of each social-media post and the related social-media post to a recommendation engine, said recommendation engine comprising: sending the calculated social-impact score of each social-media post and the related social-media post to at least one of: (i) knowledgebase; (ii) agent-dashboard; (iii) reporting module; and (iv) supervisor dashboard.

12. The computerized-method of claim 5, where said calculated social-impact score is according to formula I:
social-impact score=Σ(user reach*W1)+(engagement metrics*W2)+(social media interaction relevance*W3)+(social media post accuracy*W4)+(social media post clarity*W5)+(response time sensitivity*W6)+(customer emotion intensity*W7)+(contextual keywords*W8)+(customer sentiment*W9)+(customer loyalty*W10)+(customer feedback*W11), (I)
whereby:
the user reach is a parameter that measures an influence of the customer,
the engagement metrics is a parameter that assesses level of engagement generated by the social-media post,
the social-media post relevance is a parameter that evaluates relevance of the social-media post to objectives of the contact center,
the social-media post accuracy is a parameter that refers to correctness of information presented in the social-media post,
the social-media post clarity is a parameter that assesses readability and comprehensibility of language used in the social-media post,
the time sensitivity is a parameter that indicates urgency of the content of the social-media post,
the customer emotion intensity is a parameter that evaluates strength of emotions expressed in the social-media post,
the contextual keywords is a parameter that provides an analysis of presence of keywords relevant to domain of the contact center,
the customer sentiment is a parameter that assesses overall sentiment of the social-media post,
the customer loyalty is a parameter that measures loyalty of the customer,
the customer feedback is a parameter that captures response of other customers to the social-media post, and
W1-W11 are preconfigured weights assigned to the parameters.

13. A computerized-system for dynamically prioritizing social-media interactions in real-time, based on social-media posts in feeds, in a contact center, said computerized-system comprising:
one or more processors, said one or more processors are configured to:
(i) monitor by one or more processors the social-media posts in the feeds of one or more social-media platforms which are integrated to the contact center,
wherein said social-media posts have been published during a preconfigured period;
(ii) for each social-media post of a customer in each feed in the feeds:
a. calculate a quality-score by operating an Artificial intelligence (AI) driven Content Quality Analysis (ACQA) module; and
b. calculate a social-impact score based on the calculated quality score and one or more parameters;
(iii) automatically prioritize the social-media posts based on the calculated social-impact score to yield a priorities queue of social-media interactions,
wherein each social-media post represents a social-media interaction, and
(iv) automatically route social-media interactions by a routine-engine to an available agent based on the yielded priorities queue of social-media interactions.
